(19) United States
(12) Patent Application Publication
(10) Pub. No.: US 2011/0091256 A1
(43) Pub. Date: Apr. 21, 2011

(54) IMAGE FORMING APPARATUS AND METHOD OF CONTROLLING THE SAME

(75) Inventors: Shigeki NOZAWA, Toyokawa-shi (JP); Yoshiki Nakazawa, Toyokawa-shi (JP); Masazumi Ito, Toyohashi-shi (JP); Masahiro Anazawa, Toyohashi-shi (JP)

(73) Assignee: Konica Minolta Business Technologies, Inc., Chiyoda-ku (JP)

(21) Appl. No.: 12/905,250

(22) Filed: Oct. 15, 2010

(30) Foreign Application Priority Data
Oct. 19, 2009 (JP) 2009-240671

(51) Int. Cl. G03G 15/00

(52) U.S. Cl. 399/388

(57) ABSTRACT

An image forming apparatus includes a first rotator by which one surface of a paper is subjected to image transferring, image fixing, or other processings, a second rotator which presses the paper against the first rotator from the other surface of the paper, a space changing unit which changes a space between axial cores of the first rotator and the second rotator, a feeding unit which feeds the paper between the first rotator and the second rotator, and a control unit which adjusts a driving timing of the space changing unit in accordance with the driving of the feeding unit, wherein when the paper is thinner than a set value, the control unit makes the paper enter between both the rotators in a state where the second rotator is pressed against the first rotator, and when the paper is equal to or thicker than the set value, the control unit controls to press the second rotator against the first rotator at a timing where a distal end of the paper passes through between both the rotators.

### CROSS-REFERENCE TO RELATED APPLICATION

This application is based on application No. 2009-240671 filed in Japan, the entire content of which is hereby incorporated by reference.

### BACKGROUND OF THE INVENTION

1. Field of the Invention

The present invention relates to an image forming apparatus. As the image forming apparatus, various devices such as a single function copying machine, a single function facsimile machine, a printer, a plotter, a complex machine simultaneously having a plurality of functions such as a copying function, a facsimile function, a scanning function and the like are included.

2. Related Art

An image forming apparatus such as a single function copying machine and a complex machine generally includes a secondary transfer portion which transfers a toner image onto a paper, and a fixing portion which fixes an image onto the paper. In the case of a color-compliant image forming apparatus, the secondary transfer portion includes a secondary transfer belt (intermediate transfer belt), a belt driving roller and a secondary transfer roller. The secondary transfer belt is wound around the belt driving roller. The secondary transfer roller pressurizes a paper against the secondary transfer belt and the belt driving roller. A toner image is transferred onto the paper by pressingly nipping the paper by the belt driving roller and the secondary transfer roller and applying a voltage. In this case, an outer circumferential portion of the secondary transfer roller is made of an elastic material such as a rubber. Further, the secondary transfer roller forms a nip by pressure against the belt driving roller so as to make the transferring reliable.

Papers (recording media) having various thicknesses are used in the image forming apparatus. However, a specific problem arises in some case if the thickness of the paper is different. Then, improving ideas for addressing such difference in thickness of a paper have been proposed. Examples of the improving ideas are as follows. In Japanese Unexamined Patent Publication No. 2005-316320, a configuration in which a secondary transfer roller is arranged to be movable to be close to or far from a belt driving roller so as to change a nip width of the secondary transfer roller depending on thicknesses of papers is employed in order to address a problem that vibration generates on the secondary transfer portion if the thickness of the paper is larger.

On the other hand, in Japanese Unexamined Patent Publication No. 2008-33033, as an improvement of a fixing portion, a configuration in which a space between a fixing roller and a pressure roller is adjusted depending on thicknesses of papers is employed in order to prevent a paper from twining around the fixing roller and the pressure roller.

An outer circumferential portion of the secondary transfer roller arranged on the secondary transfer portion is made of an elastic material as described above. However, as a problem caused by the thickness of a paper, the inventors have found that the secondary transfer roller is damaged or print failure is caused if a paper is thick as much as 0.4 mm or more, for example.

That is to say, a paper is formed by solidifying cellulose into a sheet-form and has a significantly high density. Therefore, a sharp edge is formed by both of front and back surfaces of the paper and an outer circumferential surface. When a paper P has an ordinary thickness as in a plain paper as shown in FIG. 7A, the edge can be neglected and the paper P can be made to enter into a secondary transfer portion in a state where a belt driving roller 40 and a secondary transfer roller 41 are made into close contact with each other. However, when a paper has a thickness of a certain degree or larger, the edge is manifested. This results in a failure that an edge P1 of the paper P collides against a rubber layer 41a of the secondary transfer roller 41 and the rubber layer 41a is damaged, as shown in FIG. 7B. It is to be noted that in FIGS. 7A and 7B, a reference numeral 42 indicates a secondary transfer belt. Then, the damage of the rubber layer 41a becomes advanced as the rubber layer 41a is repeatedly used, or even worse, the rubber layer 41a fractures.

Further, if the paper P enters into between the belt driving roller 40 and the secondary transfer roller 41, the rubber layer 41a of the secondary transfer roller 41 is dented and deformed so that a nip is formed. However, if the thickness of the paper P is significantly large as much as 0.4 mm or larger, for example, the rubber layer 41a of the secondary transfer roller 41 is locally pressurized at the beginning of the entrance of the paper P so that a deep recess 43 is formed. Further, even if the secondary transfer roller 41 rotates, the recess 43 does not disappear completely and remains as shown by a dashed-dotted line. Therefore, pressing failure of the paper P is generated to cause transfer failure. As a result, printing failure is caused.

Further, in the fixing portion, a surface layer of a heating roller and/or a pressure roller is made of a rubber having high elasticity. Therefore, there is a fear that fixing failure is caused because the heating roller and/or the pressure roller is damaged and the recess remains due to the edge of the paper.

With the conventional techniques disclosed in Japanese Unexamined Patent Publication Nos. 2005-316320 and 2008-33033, although the space between the rollers can be changed depending on thicknesses of papers, the paper is only fed between the rollers in a state where the space is previously set. Therefore, the above-described failures that the rubber layer is damaged and the recess remains cannot be eliminated.

The present invention has been achieved for the purpose of improving such problems.

### SUMMARY OF THE INVENTION

The present inventors have studied repeatedly in order to improve the conventional techniques and have achieved the invention. The invention has multiphase applications.

An image forming apparatus according to a first aspect of the invention includes a first rotator by which one surface of a paper is subjected to image transferring, image fixing, or other processings, a second rotator which presses the paper against the first rotator from the other surface of the paper, a space changing unit which changes a space between the first rotator and the second rotator, a feeding unit which feeds the paper between the first rotator and the second rotator, and a control unit which adjusts a driving timing of the space changing unit in accordance with the driving of the feeding unit. In the image forming apparatus, when the paper is thinner than a set value, the control unit makes the paper enter between both the rotators in a state where the second rotator is pressed against the first rotator, and when the paper is equal to or thicker than the set value, the control unit controls to press the second rotator against the first rotator at a timing where a distal end of the paper passes through between both the rotators.

The first aspect of the invention can be developed in various ways. The examples thereof are described as second to eleventh aspects of the invention. In the second aspect of the invention, an outer circumferential layer of at least one of the first rotator and the second rotator is formed with an elastic material.

The third aspect of the invention is a developed example of a control mode. That is, in the third aspect of the invention, when the paper is thinner than a set value, the paper is controlled to enter between both the rotators in a state where the second rotator is pressed against the first rotator, and when the paper is equal to or thicker than the set value, a space between both the rotators is controlled to be large such that the paper is not pressingly nipped until a distal end of the paper enters between both the rotators and the space between both the rotators is controlled to be narrower such that the paper is pressingly nipped after the distal end of the paper has passed through between both the rotators.

The fourth aspect of the invention is a developed example of the third aspect of the invention. In the fourth aspect of the invention, when the paper is equal to or thicker than the set value and there is not a space having a predetermined size or larger between a distal end of the paper in the paper transportation direction and an image area and there is a space having the predetermined size or larger between a rear end of the paper and the image area, a space having the predetermined size or larger is controlled to be provided between the distal end of the paper and the image area by making the image area deviate to the rear side and forming an image.

The fifth aspect of the invention is also a developed example of the third aspect of the invention. In the fifth aspect of the invention, when the paper is equal to or thicker than the set value and there is not a space having the predetermined size or larger between a distal end of the paper in the paper transportation direction and an image area and there is a space having the predetermined size or larger between a rear end of the paper and the image area, an image is formed on the paper while the front and the rear sides of the image are inverted.

The sixth aspect of the invention is also a developed example of the third aspect of the invention. In the sixth aspect of the invention, when the paper is equal to or thicker than the set value and there is not a space having the predetermined size or larger between a distal end of the paper in the paper transportation direction and an image area and between a rear end of the paper and the image area, a space having the predetermined size or larger is provided between the distal end of the paper and the image area by contracting and forming an image.

In the seventh and eighth aspects of the invention, each application component is embodied. In the seventh aspect of the invention, the first rotator is a transfer roller for transferring an image onto a paper. On the other hand, in the eighth aspect of the invention, the first rotator is a fixing roller for fixing an image onto a paper.

An image forming apparatus according to a ninth aspect of the invention includes an intermediate transfer belt which bears a toner image on an outer circumferential surface, a transfer roller at least of which outer circumferential layer is formed with an elastic material, and which is arranged so as to be opposed to the intermediate transfer belt and rotates in synchronization with the intermediate transfer belt, a space changing unit which switches states between an advanced state where the transfer roller is in pressure contact with the intermediate transfer belt and a retreated state where the transfer roller is spaced from the intermediate transfer belt, a feeding unit which feeds a paper between the intermediate transfer belt and the transfer belt, a thickness judgment unit which judges thickness of the paper, and a control unit which changes a timing where the transfer roller is switched from the retreated state to the advanced state by the space changing unit based on the thickness judgment unit. In the image forming apparatus, when the paper is equal to or thicker than a set value, the control unit makes the timing where the transfer roller is made into pressure contact with the intermediate transfer belt delay in comparison with that when the paper is thinner than the set value.

The ninth aspect of the invention can be developed and embodied in various ways. As an example thereof, in the tenth aspect of the invention, when the paper is thinner than the set value, the paper is controlled to enter between the intermediate transfer belt and the transfer roller in a state where the transfer roller is in pressure contact with the intermediate transfer belt and when the paper is equal to or thicker than the set value, the paper is controlled to enter between the intermediate transfer belt and the transfer roller before the transfer roller is made into pressure contact with the intermediate transfer belt.

The eleventh aspect of the invention is obtained by embodying the ninth aspect of the invention. In the eleventh aspect of the invention, when the paper is equal to or thicker than the set value, the control unit controls to drive the space changing unit at a timing where a distal end of the paper is pressingly nipped by the intermediate transfer belt and the transfer roller.

The invention also includes a method of controlling the image forming apparatus. That is, the image forming apparatus includes a first rotator by which one surface of a paper is subjected to image transferring, image fixing, or other processings, a second rotator which presses the paper against the first rotator from the other surface of the paper, a space changing unit which changes a space between axial cores of the first rotator and the second rotator, a feeding unit which feeds the paper between the first rotator and the second rotator. Further, when the paper is thinner than a set value, the paper is made to enter between both the rotators in a state where the second rotator is pressed against the first rotator, and when the paper is equal to or thicker than the set value, the second rotator is pressed against the first rotator at a timing where a distal end of the paper passes through between both the rotators.

In the present invention, an expression “paper” indicates a sheet-form recording medium on which an image is formed. Accordingly, a material or a configuration of the paper is not particularly limited. For example, a resin film, a resin sheet, a laminate body of a resin and a paper are included as the paper.

### BRIEF DESCRIPTION OF THE DRAWINGS

FIG. 1A is a schematic cross-sectional view illustrating an image forming apparatus according to an embodiment. FIG. 1B is an enlarged cross-sectional view illustrating a secondary transfer portion.

FIG. 2 is a plan view of FIG. 1B.

FIG. 3 is a cross-sectional view cut along a line in FIG. 2.

FIGS. 4A to 4C are explanatory diagrams illustrating a control mode.

FIGS. 5A to 5C are explanatory diagrams illustrating a control mode.

FIG. 6 is a flowchart illustrating an example of a control mode.

FIGS. 7A and 7B are views illustrating a conventional technique.

### DESCRIPTION OF THE PREFERRED EMBODIMENTS

Hereinafter, an embodiment of the invention will be described with reference to drawings. An image forming apparatus according to the embodiment is embodied as a complex machine simultaneously having a plurality of functions such as a copying function, a print function, a scanning function, and a facsimile function.

### 1. Outline of Image Forming Apparatus

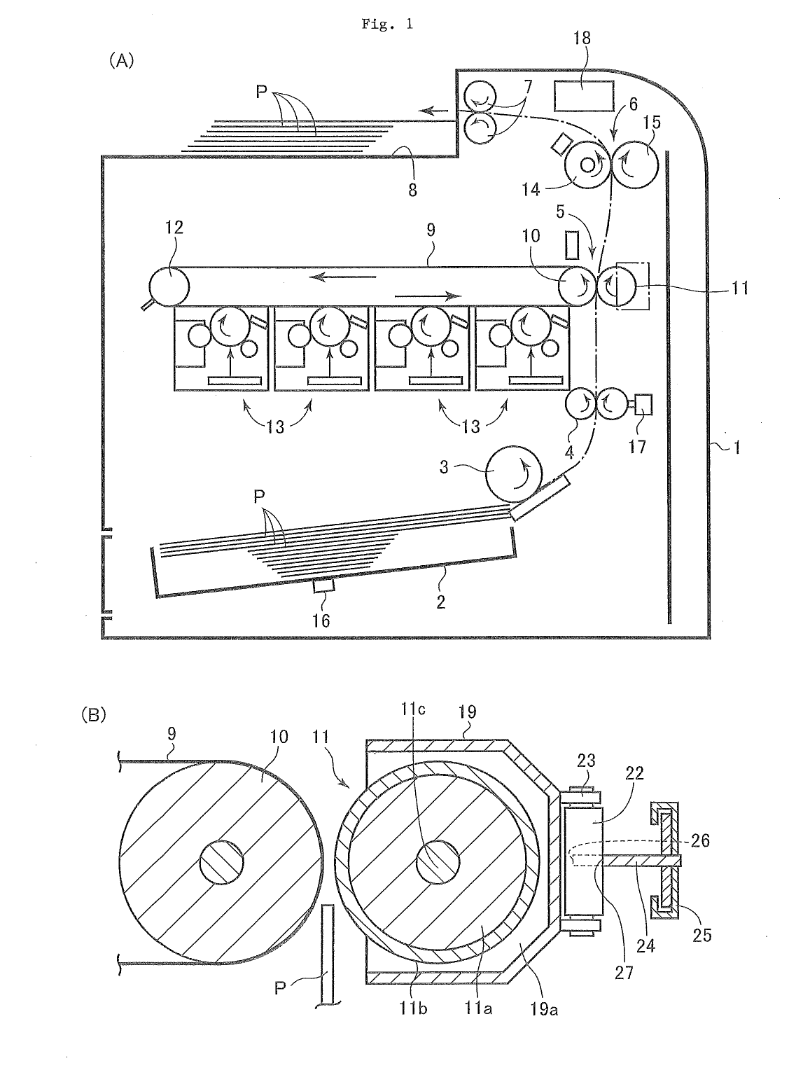

As shown in FIGS. 1A and 1B, an image forming apparatus includes a main body case 1 and a paper feeding tray 2 is arranged in the main body case 1 at a lower portion. Papers P accommodated in the paper feeding tray 2 are discharged onto a catch tray 8 through a pick up roller 3, a pair of timing rollers 4, a secondary transfer portion 5, a fixing portion 6, and a pair of discharge rollers 7. The papers P are transported from a lower side to an upper side in the embodiment.

The secondary transfer portion 5 has a secondary transfer belt 9, a belt driving roller 10 and a secondary transfer roller 11 as main components. The secondary transfer belt 9 is wound around the belt driving roller 10. The secondary transfer roller 11 is arranged so as to be opposed to the belt driving roller 10. Each paper P is pressurized against the secondary transfer belt 9 by the secondary transfer roller 11. The secondary transfer roller 11 is an example of a first rotator described in Claims and the belt driving roller 10 is an example of a second rotator.

Note that the first rotator and the second rotator described in Claims are relative concepts. Therefore, in the embodiment, the belt driving roller 10 may be a specific example of the first rotator and the secondary transfer roller 11 may be a specific example of the second rotator. Further, the secondary transfer belt 9 may be a specific example of the rotation body.

The secondary transfer belt 9 is also wound around a driven roller 12. Toners are transferred onto the secondary transfer belt 9 which goes around from four image formation units 13. It is needless to say that the four image formation units 13 are divided into yellow, magenta, cyan, and black. Since configurations of the image formation units 13 are not directly related to the invention, description thereof is omitted. The fixing portion 6 has a fixing roller (heating roller) 14 and a pressure roller 15.

A paper size sensor 16 is arranged on a lower surface of the paper feeding tray 2. The thickness of the paper P is detected by detecting a space between the pair of timing rollers 4 with a paper thickness sensor 17 in the embodiment. Accordingly, the timing rollers 4 are commonly used as paper thickness detection units. A thickness detection sensor may be provided at a position different from the position of the timing rollers 4. In this case, the thickness detection sensor needs to be provided at an upstream side of the secondary transfer roller 11.

The image forming apparatus includes a controller 18 which functions as a control unit described in Claims. The controller 18 is shown on an upper portion in the image forming apparatus in FIG. 1A. However, the controller 18 is schematically and conceptually illustrated in FIG. 1A and the arrangement position thereof can be arbitrary set. Further, the controller is formed of a CPU as a core component, a memory, a circuit, and the like. In general, the controller is integrally formed with a control unit which controls various members constituting the image forming apparatus in many cases. Constituent components of the controller 18 may be separated and the controller can be replaced by an external apparatus such as a personal computer, of course.

### 2. Configuration of Secondary Transfer Portion

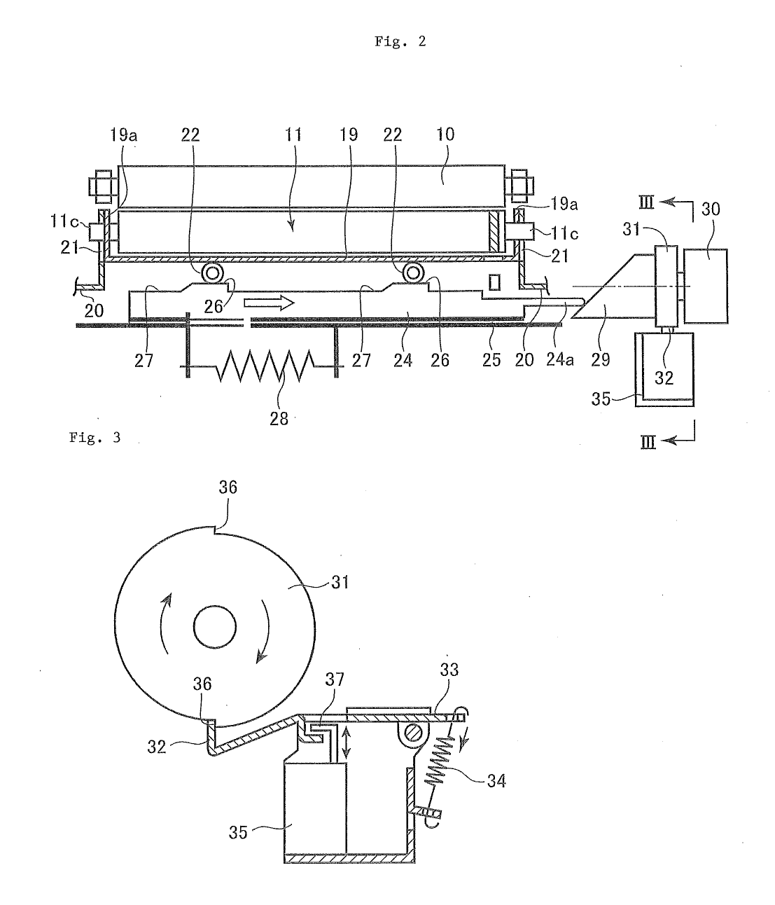

Next, the secondary transfer portion 5 is described with reference to FIG. 1B to FIG. 4C. The secondary transfer roller 11 is configured by winding an elastic material layer (rubber layer) 11b around a base material 11a and surrounded by a holder bracket 19 from an opposite side of the belt driving roller 10. The holder bracket 19 has left and right side plates 19a and a rotational axis 11c of the secondary transfer roller 11 is fitted into the left and right side plates 19a so as to be rotatable.

Further, left and right ends of the rotational axis 11c of the secondary transfer roller 11 are slidably fitted into long holes 21 provided on guide brackets 20. The guide brackets 20 are fixed to constituent members of the image forming apparatus. The long holes 21 are extended long in the direction close to and far from the secondary transfer portion 5. Accordingly, the secondary transfer roller 11 can move so as to be close to and far from the belt driving roller 10 together with the holder bracket 19.

Guide rollers 22 are attached to a bottom of the holder bracket 19 at an opposite side of the secondary transfer portion 5 through bearing fragments 23. Each guide roller 22 has a rotational axis which is perpendicular to an axial core of the secondary transfer roller 11. A pair of the guide rollers 22 are arranged at positions which are distanced from each other in the axial core direction of the secondary transfer roller 11. A slider 24 is arranged at an opposite side of the holder bracket 19 with respect to the guide rollers 22. The slider 24 has a form extending long in the same direction as an axial line of the secondary transfer roller 11. Further, the slider 24 is held by a slide guiding member 25 so as to be slidable along the axial core direction of the secondary transfer roller 11.

Two stage cam portions 26, 27 which abut against the guide rollers 22 are formed on the slider 24. The both cam portions 26, 27 are continuously formed through inclined faces. The holder bracket 19 is biased in the direction separated away from the belt driving roller 10 with a spring (not shown). Accordingly, if the slider 24 slides and the guide rollers 22 selectively abut against the two cam portions 26, 27, the secondary transfer roller 11 moves to an advanced position and a retreated position. The secondary transfer roller 11 is in pressure contact with the secondary transfer belt 9 supported by the belt driving roller 10 at the advanced position. A space is set between the secondary transfer roller 11 and the secondary transfer belt 9 at the retreated position.

The slider 24 is pulled by a spring 28 to a position where the secondary transfer roller 11 is retreated. Accordingly, if the slider 24 slides against the spring 28, the secondary transfer roller 11 advances through the holder bracket 19.

An end face cam 29 is used as means for advancing the slider 24 against the spring 28. An end 24a of the slider 24 abuts against a cam face of the end face cam 29. The cam face of the end face cam 29 is cut into a form that the cam face is inclined with respect to an axial core thereof. Accordingly, every time the cam face rotates by 180 degree, the slider 24 reciprocates. The end face cam 29 is driven by a motor 30 as an example of an actuator. Further, the end face cam 29 is positioned accurately by a rotation angle regulation unit so as to rotate by 180° for each rotation.

The rotation angle regulation unit has a rotor 31, a lever 33, a spring 34, and a reciprocating solenoid 35. The rotor 31 rotates together with the end face cam 29. The lever 33 has an engagement claw 32 which abuts against an outer circumferential surface of the rotor 31. The spring 34 biases the lever 33 toward the rotor 31. The solenoid 35 separates the lever 33 from the rotor 31. Engagement step portions 36 on which the engagement claw 32 catches are formed on the rotor 31 so as to be symmetry with respect to an axial core thereof. On the other hand, an operation fragment 37 which makes the lever 33 secede from the rotor 31 is provided on the reciprocating solenoid 35.

The motor 30 is started to be driven in a state where the lever 33 is pulled by the operation fragment 37. When the rotor 31 is started to rotate, excitation of the reciprocating solenoid 35 is released so as to make the operation fragment 37 protrude. Then, the lever 33 is biased by the spring 34 such that the engagement craw 32 of the lever 33 is made into pressure contact with the outer circumferential surface of the rotor 31. The engagement claw 32 abuts against the engagement step portion 36 so that the end face cam 29 is positioned accurately.

In the embodiment, a timing where the paper P is made into pressure contact with the secondary transfer roller 11 (that is, a position where the paper P is started to be pressingly nipped by the secondary transfer belt 9 and the secondary transfer roller 11) can be changed depending on thicknesses of papers. Therefore, even when the outer circumferential layer of the secondary transfer roller 11 is formed with the elastic material layer 11b, damage of the elastic material layer 11b or remaining of the recess due to collision of the paper can be prevented or significantly suppressed. This may result in contribution to improvement in durability of the secondary transfer roller 11 and preservation of print quality. Further, in a case where the paper P is thick, the paper can be prevented from slipping when a distal end of the paper P hits the secondary transfer belt 9 and the secondary transfer roller 11.

### 3. Explanation of Control Mode

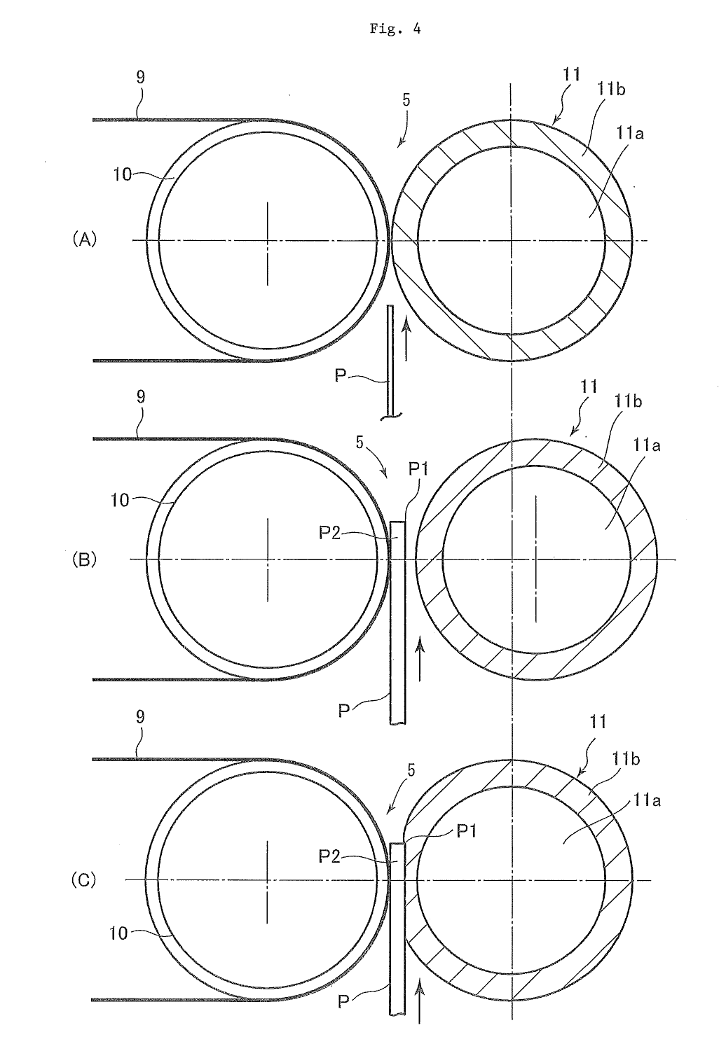

As described above, the secondary transfer roller 11 can be selectively positioned between the advanced position where the secondary transfer roller 11 is in pressure contact with the secondary transfer belt 9 and the retreated position where the secondary transfer roller 11 is spaced from the secondary transfer belt 9. In this section, control modes relating to the thickness of the paper P are described. When the paper P is thin as in the case of a plain paper, for example, a problem that the elastic material layer 11b is damaged or the recess remains is not caused. Therefore, in such a case, the paper P is fed in a state where the secondary transfer roller 11 is made into close contact (into pressure contact) with the secondary transfer belt 9 (a nip is formed on the elastic material layer 11b of the secondary transfer roller 11 because the elastic material layer 11b is pressurized against the secondary transfer belt 9) as shown in FIG. 4A.

On the other hand, when the paper P is significantly thick as much as 0.4 mm or larger, an distal end P2 of the paper P is passed through between both the rollers 10, 11 in a state where the secondary transfer roller 11 is retreated as shown in FIG. 4B. Then, the secondary transfer roller 11 is advanced so that the distal end P2 of the paper P is pressingly nipped by both the rollers 10, 11. That is to say, the pressing timing of the secondary transfer roller 11 is delayed. Therefore, the edge P1 at the distal end of the paper P can be prevented from colliding against the secondary transfer roller 11. As a result, the elastic material layer 11b can be prevented from being damaged while preventing the recess from remaining. The degree that the pressing timing of the secondary transfer roller 11 is delayed can be changed in accordance with conditions such as thickness of the paper P.

Note that not a configuration in which the secondary transfer roller 11 is advanced and the paper is pressingly nipped after the distal end P2 of the paper P passes through a portion between the axial cores of both the rollers 10, 11 but a configuration in which the secondary transfer roller 11 is advanced at a timing where the distal end P2 of the paper P passes through the portion between the axial cores of both the rollers 10, 11 can be employed. In such a case, damage of the rubber layer 11a caused by the collision of the edge P1 of the paper P against the secondary transfer roller 11 can be prevented.

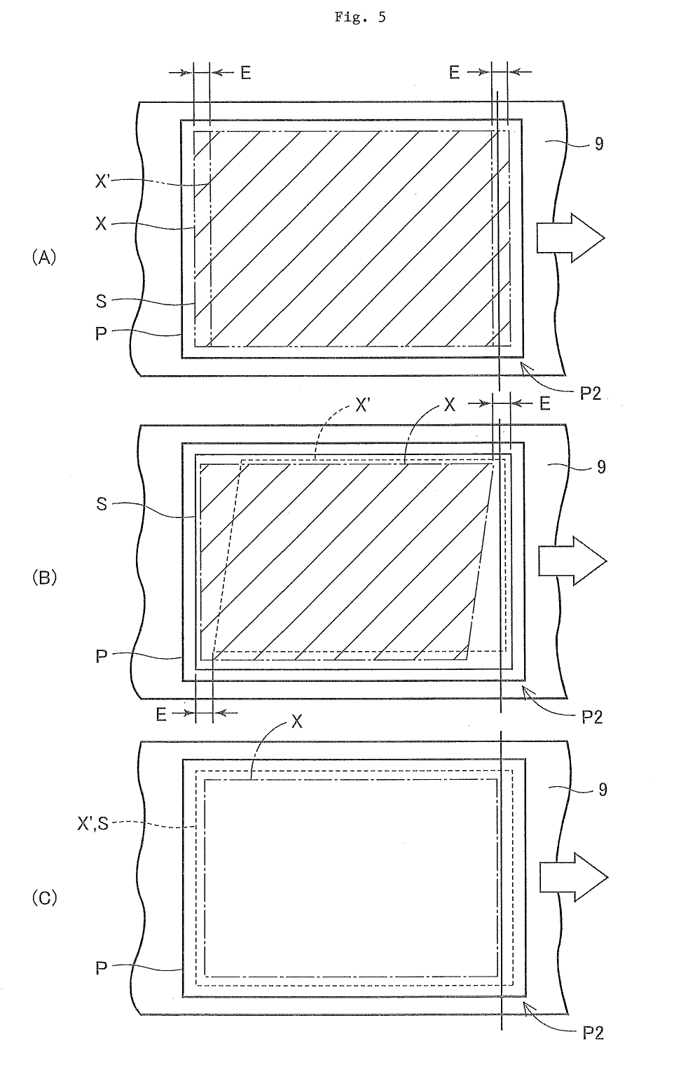

In FIGS. 5A to 5C, control modes are illustrated by relating to an image area. In an example as shown in FIG. 5A, in a state where the paper is read by a scanner, a margin is not provided between a distal end of a printable range (image formation range) S of the paper P and a distal end of an image area X′ but a margin E is provided between a rear end of the printable range S and a rear end of the image area X′.

In FIG. 5A, a margin is provided on the distal end P2 of the paper P by deviating an image area X after printed (after image formation) to the rear side with respect to the paper P by the margin E. Before the distal end P2 of the paper P passes through a portion opposed to the secondary transfer roller 11 and the distal end P2 of the image area X passes through between both the rollers 10, 11, the paper P is made into pressure contact with the belt driving roller 10 by the secondary transfer roller 11. Therefore, a pressing timing of the secondary transfer roller 11 (a timing where the paper is pressingly nipped by both the rollers 10, 11) is delayed without causing interruption of an image.

In an example shown in FIG. 5B, in a state where the paper is read by a scanner, little or no margin is provided between a distal end of the printable range S of the paper P and an image area X′ but a margin E having a width at some degree is provided between a rear end of the printable range S and the image area X′. In this case, a margin where the paper can be pressingly nipped by both the rollers 10, 11 is provided on the distal end P2 of the paper P by inverting the front and rear sides of the image area X after printed. Therefore, the timing where the sheet is made into contact with the belt driving roller 10 by the secondary transfer roller 11 (timing where the secondary transfer roller 11 is advanced) is delayed without causing interruption of an image. In this case, since the image is not deviated in comparison with the method as shown in FIG. 5A, there is an advantage that a printed image just as a user intended can be made.

In an example as shown in FIG. 5C, in a state where the paper is read by a scanner, the image area X′ is filled in the printable range S. In this case, a margin where the paper can be nipped and held by both the rollers 10, 11 is provided between the image area X and a distal end of the printable area S by slightly contracting the entire of the actual image area X. Therefore, the pressing timing of the secondary transfer roller 11 is delayed without causing interruption of an image.

It is to be noted that in the control modes as shown in FIGS. 5A to 5C, it is preferable that the control contents are displayed on a display. Further, the processings to be processed can be displayed on the display to inquire of a user whether the processings are executed.

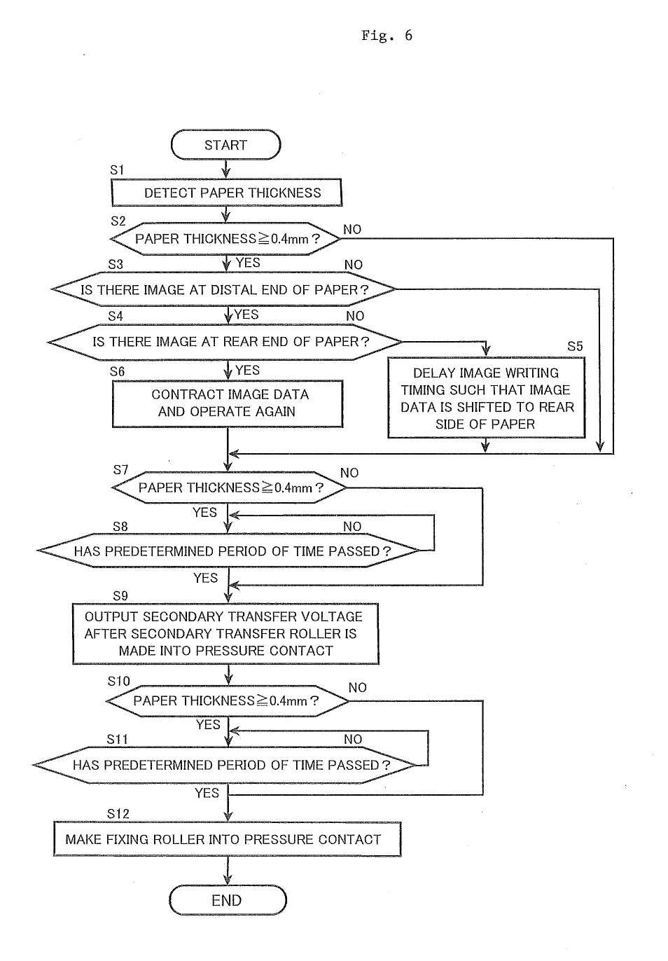

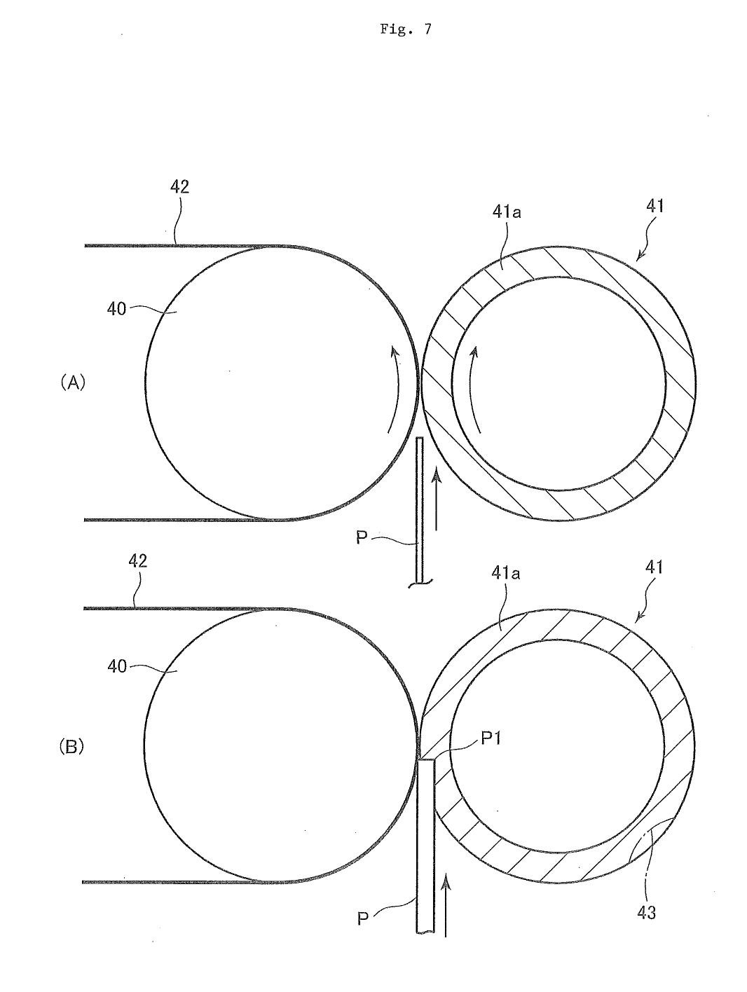

FIG. 6 is a flowchart illustrating a control mode. The control mode is described next. The control mode obtained by combining the control modes as shown in FIGS. 5A to 5C is shown in FIG. 6. At first, a thickness of the paper P is detected by the paper thickness sensor 17 (S1). Then, it is judged whether the thickness is 0.4 mm or larger (S2). If the paper thickness is smaller than 0.4 mm, the paper P enters into the secondary transfer portion 5 in a state where the secondary transfer roller 11 is advanced.

On the other hand, if the thickness of the paper P is 0.4 mm or larger, it is judged whether there is an image at the distal end P2 of the paper P (that is, whether there is a margin where the paper can be nipped and held by both the rollers 10, 11 at the distal end of the paper) based on paper size data and image data (S3). If there is a margin at the distal end P2 (S3=NO), a state where the secondary transfer roller 11 is retreated is kept for a predetermined period of time (S8) and the secondary transfer roller 11 is advanced after the distal end P2 of the paper P enters into the secondary transfer portion 5 (S9).

In step 3 (S3), if it is judged that there is an image at the distal end P2 and there is no a margin for nipping and holding the paper (S3=YES), it is judged whether there is an image at the rear end of the paper P (whether there is a margin where the paper can be nipped and held by both the rollers 10, 11 at a rear end of the paper) (S4). If it is judged that there is no margin on the distal end P2 of the paper P and there is a margin at the rear end of the paper P (S3=YES, S4=NO), a direction is output to laser exposure portions of the image formation units 13 so as to delay the writing timing by a predetermined dimension (for example, approximately 10 mm) (S5). Then, a state where the secondary transfer roller 11 is retreated is kept for a predetermined period of time (S8) and the secondary transfer roller 11 is advanced after the distal end P2 of the paper P enters into the secondary transfer portion 5 (S9).

If it is judged that there is no margin for nipping and holding the paper at the distal end P2 and the rear end of the paper P (S3=YES, S4=YES), an image contraction direction is output to each of the image formation units 13 so that a contracted toner image is transferred onto the secondary transfer belt 9 (S6). Then, a state where the secondary transfer roller 11 is retreated is kept for a predetermined period of time and the secondary transfer roller 11 is advanced after the paper P enters into the secondary transfer portion 5. If the image has been already formed on the secondary transfer belt 9, resetting of scratching off the image from the secondary transfer belt 9 is performed and a contracted image is formed again.

As is partially described above, the image formation units 13 and the like are controlled if necessary after the processings in steps 1 through 6 (S1 through S6) are performed. Then, the paper P enters into the secondary transfer portion 5 so that the secondary transferring is performed. The process is described as follows. That is, after the processings in steps 1 through 6 are performed, it is judged that the paper thickness is 0.4 mm or larger again. If it is judged that the paper thickness is 0.4 mm or larger (S7=YES), it is judged whether the predetermined period of time has passed (S8). If it is judged that a predetermined period of time has passed (S8=YES), the motor 30 is driven to make the secondary transfer roller 11 into pressure contact with the secondary transfer belt 9 (belt driving roller 10) so that an image is transferred onto the paper P by applying a secondary transfer voltage to the secondary transfer roller 11 (S9). In the embodiment, the belt driving roller 10 is grounded (earthed) and a voltage is applied to the secondary transfer roller 11. However, the relationship can be inverted.

If it is judged that the paper thickness is smaller than 0.4 mm in step 7 (S8=NO), the motor 30 is driven immediately to make the secondary transfer roller 11 into pressure contact with the driving roller 10. Then, the paper P is made to enter between the secondary transfer belt 9 and the secondary transfer roller 11, and a secondary transfer voltage is applied (S9). If it is judged that the paper thickness is 0.4 mm or larger in step 7, judgment whether a predetermined period of time has passed in step 8 is performed a plurality of times with significantly short time intervals (time is integrated). If the predetermined period of time has not passed, the process returns and a processing in step 8 is performed again. It is needless to say that a predetermined period of time can be measured by a timer unit. In a case where the control mode as shown in FIG. 5B is employed, an image inversion direction is output to the image formation units 13 in step 5.

If the paper thickness is 0.4 mm or larger, it is judged whether the predetermined period of time has passed in step 8 in order to delay the timing where the paper is made into pressure contact with the driving roller 10 by the secondary transfer roller 11. The “predetermined period of time” here is set by a relationship between a feeding speed of the paper P and a dimension of the distal end P2 of the paper P to enter between both the rollers 10, 11. A measurement starting time point for the predetermined period of time can be set to a feeding starting time point by the timing rollers 4, for example. However, the measurement starting time point for the predetermined period of time can be set to other time points. For example, the following method can be employed. That is, a sensor for detecting the distal end of the paper P is provided and the measurement starting time point is set to a time point where the sensor is turned ON.

In theory, processings in steps S2 through S7 can be executed while feeding the paper P by the timing rollers 4. However, in the case of the color image forming apparatus having the secondary transfer belt 9 as in the embodiment, it takes time at some degree to perform a step of transferring an image onto the secondary transfer belt 9. Therefore, processings in steps S2 through S7 are generally executed in a state where the feeding of the paper P is stopped. Further, the paper P is started to be fed by the timing rollers 4 at timing where the image transferring onto the secondary transfer belt 9 by the image formation units 13 is finished. The measurement of “predetermined period of time” is started from the starting point of the feeding of the paper P.

In the embodiment, the thickness of the paper P is detected by the paper thickness sensor 17. However, information about paper thickness can be taken in from an input value of print information, for example. In this case, the thickness can be calculated from a weight value thereof.

As modes for reciprocating the secondary transfer roller 11, the following two modes can be exemplified. As one mode, when the thickness of the paper P is 0.4 mm or larger, the secondary transfer roller 11 is advanced with the timing delayed. Then, the secondary transfer roller 11 is retreated after the paper P has passed through the secondary transfer portion 5. In this mode, a state where the secondary transfer roller 11 is retreated is set to a reference state. As the other mode, when the thickness of the paper P is 0.4 mm or larger, the secondary transfer roller 11 is once retreated. Then, the timing where the secondary transfer roller 11 is advanced with the timing delayed. After that, the secondary transfer roller 11 is kept to be advanced even if the paper P has passed through the secondary transfer portion 5. In this mode, a state where the secondary transfer roller 11 is advanced is set to a reference state. In the embodiment as shown in FIG. 6, the former mode in which the retreated state is set to be a reference state is employed. However, it is needless to say that the latter mode can be employed.

In the control mode, the pressure roller 15 of the fixing portion 6 is movable. The thickness of the paper P is judged when the paper P enters into the fixing portion 6 after the secondary transferring (S10). If the paper thickness is 0.4 mm or larger (S10=YES), it is judged whether a predetermined period of time has passed (S11). If the predetermined period of time has passed, the pressure roller 15 is made into pressure contact with the fixing roller 14 so as to fix an image (S12). If the thickness of the paper P is smaller than 0.4 mm, the paper P is made to enter into the fixing portion 6 in a state where the pressure roller 15 is advanced. Note that although either of the fixing roller 14 or the pressure roller 15 may be set to a first rotator, the fixing roller 14 is set to be an example of the first rotator in the embodiment.

In the fixing process, the judgment whether the predetermined period of time has passed (S11) is also performed a plurality of times with short time intervals. The measurement starting time point for “predetermined period of time” in step 11 can be made common to that in step 8. Further, other time points (for example, a time point where the secondary transfer roller 11 is advanced in step 9, or a time point where a voltage is started to be applied) can be set to be a reference point. A sensor dedicated for detecting the paper P fed can be provided for starting to measure the “predetermined period of time” in step 11. In the fixing process, as for the pressure roller 15, the retreated state is set to a reference state in some case and the advanced state is set to a reference state in other cases.

Note that a voltage is needed to be stably applied to the toner image in the secondary transfer portion 5 and time for stabilizing the voltage is needed somewhat after the paper is started to be pressingly nipped by both the rollers 10, 11. Therefore, a margin where the paper P is pressingly nipped by both the rollers 10, 11 while being fed is needed to be provided somewhat at the distal end P2 of the paper P. However, since heat is required to be necessarily applied to an image in the fixing portion 6, when the invention is applied to the fixing portion 6 only, it is preferable that the timing where the paper is started to be pressingly nipped on the fixing portion 6 is made earlier than that on the secondary transfer portion 5. For example, it is preferable that the paper is pressingly nipped after the distal end of the paper enters by approximately 5 mm.

In a case where the timings where the paper is pressingly nipped are deviated on both the secondary transfer portion 5 and the fixing portion 6, a margin is provided at the distal end P2 of the paper P by deviating the timing on the secondary transfer portion 5. Therefore, it is sufficient that the nipping timing is deviated on the fixing portion 6 by the same dimension as that on the secondary transfer portion 5. However, in a case where the timing is deviated on the fixing portion 6 only, there is a possibility that an image is formed on the distal end of the printable range S of the paper P. Therefore, the pressure-contact timing is preferably made earlier than that on the secondary transfer portion 5 in order that the dimension for deviating the nipping timing is reduced as much as possible so as to reliably fix the image.

It is to be noted that in the case of a network system or a remote control system in which a print direction is output from a personal computer to an image forming apparatus, the control unit can be provided on a device separated from the image forming apparatus such as a personal computer.

### 4. Others

The present invention can be embodied in various ways other than the above embodiment. For example, as a space adjustment unit, a second rotator such as a belt driving roller can be moved or both the rotators can be moved. Further, the adjustment mode of a space between the first rotator and the second rotator is not limited to the two stage system of advancement and retreat. A configuration in which the space between the first rotator and the second rotator can be adjusted in three or more stages or adjusted with no stage can be employed.

The space adjustment unit which adjusts a space between the rollers is not limited to the cam system described in the embodiment. However, the second rotator can be reliably held so as not to retreat if the cam system as in the embodiment is employed.

What is claimed is:

1. An image forming apparatus comprising:
a first rotator by which one surface of a paper is subjected to image transferring, image fixing, or other processings;
a second rotator which presses the paper against the first rotator from the other surface of the paper;
a space changing unit which changes a space between axial cores of the first rotator and the second rotator;
a feeding unit which feeds the paper between the first rotator and the second rotator; and
a control unit which adjusts a driving timing of the space changing unit in accordance with the driving of the feeding unit, wherein when the paper is thinner than a set value, the control unit makes the paper enter between both the rotators in a state where the second rotator is pressed against the first rotator, and when the paper is equal to or thicker than the set value, the control unit controls to press the second rotator against the first rotator at a timing where a distal end of the paper passes through between both the rotators.

2. The image forming apparatus according to claim 1,
wherein an outer circumferential layer of at least one of the first rotator and the second rotator is formed with an elastic material.

3. The image forming apparatus according to claim 1,
wherein when the paper is thinner than a set value, the paper is controlled to enter between both the rotators in a state where the second rotator is pressed against the first rotator,
when the paper is equal to or thicker than the set value, a space between both the rotators is controlled to be large such that the paper is not pressingly nipped until a distal end of the paper enters between both the rotators and the space between both the rotators is controlled to be narrower such that the paper is pressingly nipped after the distal end of the paper has passed through between both the rotators.

4. The image forming apparatus according to claim 3,
wherein when the paper is equal to or thicker than the set value and there is not a space having a predetermined size or larger between a distal end of the paper in the paper transportation direction and an image area and there is a space having the predetermined size or larger between a rear end of the paper and the image area, a space having the predetermined size or larger is controlled to be provided between the distal end of the paper and the image area by making the image area deviate to the rear side and forming an image.

5. The image forming apparatus according to claim 3,
wherein when the paper is equal to or thicker than the set value and there is not a space having the predetermined size or larger between a distal end of the paper in the paper transportation direction and an image area and there is a space having the predetermined size or larger between a rear end of the paper and the image area, an image is controlled to be formed on the paper while the front and the rear sides of the image are inverted.

6. The image forming apparatus according to claim 3,
wherein when the paper is equal to or thicker than the set value and there is not a space having the predetermined size or larger between a distal end of the paper in the paper transportation direction and an image area and between a rear end of the paper and the image area, a space having the predetermined size or larger is provided between the distal end of the paper and the image area by contracting and forming an image.

7. The image forming apparatus according to claim 1,
wherein the first rotator is a secondary transfer roller for transferring an image onto a paper.

8. The image forming apparatus according to claim 1,
wherein the first rotator is a fixing roller for fixing an image onto a paper.

9. An image forming apparatus comprising:
an intermediate transfer belt which bears a toner image on an outer circumferential surface;
a transfer roller at least of which outer circumferential layer is formed with an elastic material, and which is arranged so as to be opposed to the intermediate transfer belt and rotates in synchronization with the intermediate transfer belt;
a space changing unit which switches states between an advanced state where the transfer roller is in pressure contact with the intermediate transfer belt and a retreated state where the transfer roller is spaced from the intermediate transfer belt;
a feeding unit which feeds a paper between the intermediate transfer belt and the transfer belt;
a thickness judgment unit which judges thickness of the paper; and
a control unit which changes a timing where the transfer roller is switched from the retreated state to the advanced state by the space changing unit based on the thickness judgment unit, wherein the control unit makes the timing where the transfer roller is made into pressure contact with the intermediate transfer belt delay when the paper is equal to or thicker than a set value in comparison with that when the paper is thinner than the set value.

10. The image forming apparatus according to claim 9,
wherein when the paper is thinner than the set value, the paper is controlled to enter between the intermediate transfer belt and the transfer roller in a state where the transfer roller is in pressure contact with the intermediate transfer belt and when the paper is equal to or thicker than the set value, the paper is controlled to enter between the intermediate transfer belt and the transfer roller before the transfer roller is made into pressure contact with the intermediate transfer belt.

11. The image forming apparatus according to claim 9,
wherein when the paper is equal to or thicker than the set value, the control unit controls to drive the space changing unit at a timing where a distal end of the paper is pressingly nipped.

12. An image forming method used in an image forming apparatus that comprises a first rotator by which one surface of a paper is subjected to image transferring, image fixing, or other processings, a second rotator which presses the paper against the first rotator from the other surface of the paper, a space changing unit which changes a space between axial cores of the first rotator and the second rotator and a feeding unit which feeds the paper between the first rotator and the second rotator, the method comprising:
step of judging the paper is thinner than a set value or not;
step of making the paper enter between both the rotators in a state where the second rotator is pressed against the first rotator when the paper is thinner than the set value; and
step of making the second rotator press against the first rotator at a timing where a distal end of the paper passes through between both the rotators when the paper is equal to or thicker than the set value.
